(19) United States
(12) Patent Application Publication
(10) Pub. No.: US 2026/0326957 A1
(43) Pub. Date: Oct. 22, 2026

(54) PACKAGING APPARATUS

(71) Applicant: RENGO CO., LTD., Osaka-shi, Osaka (JP)

(72) Inventors: Ryo SASAKI, Kawaguchi-shi, Saitama (JP); Miku MURAHASHI, Kawaguchi-shi, Saitama (JP)

(73) Assignee: RENGO CO., LTD., Osaka-shi, Osaka (JP)

(21) Appl. No.: 19/491,439

(22) PCT Filed: Jun. 5, 2024
(86) PCT No.: PCT/JP2024/020443

§ 371 Date: Dec. 9, 2025

(30) Foreign Application Priority Data
Jul. 3, 2023 (JP) 2023-109193

(51) Int. Cl. B65B 59/00; B65B 5/02; B65B 59/02; B65B 61/02

(52) U.S. Cl. CPC B65B 59/001; B65B 5/024; B65B 59/02; B65B 61/02; B65B 2210/04

(57) ABSTRACT

A packaging apparatus (2) packages a stored object (90) in a packaging box (1) having a cylindrical body (1W) and changes a height of the packaging box (1) dependent on a height of the stored object (90). The packaging apparatus (2) includes a height measuring part (30) which measures a height of the stored object (90) stored in the cylindrical body (1W), and a scoring part (31) which forms a horizontal crease (L3) in a wall (10) of the cylindrical body (1W) based on a result of the height measuring part (30) to divide the wall (10) into a side wall (15) and an upper flap (16). The scoring part (31) includes a roller part (43) which holds the wall (10) of the cylindrical body (1W) and moves in a horizontal direction while rolling on both front and rear surfaces of the wall (10) to form the horizontal crease (L3).

### TECHNICAL FIELD

The present invention relates to a packaging apparatus which changes a height of a packaging box dependent on a height of a stored object.

### BACKGROUND

There is known a caser capable of packaging a packaged object (a stored object) of a different height in the same type of corrugated cardboard box (Patent Document 1). The caser detects the maximum height of a product in the corrugated cardboard box by a sensor while intermittently conveying the corrugated cardboard box in a semi-assembled state with an upper opening opened by a conveyor, and forms a crease at the boundary between the side wall and the flap of the corrugated cardboard box by first and second creasing means based on the detected height by the sensor. The first and second creasing means have a convex member pressed against the rear surface of the side wall and the others and a concave member pressed against the front surface of the side wall and the others, and the convex member and the concave member hold the side wall and the others to form the crease.

### PRIOR ART DOCUMENT

### Patent Documents

Japanese Unexamined Patent Publication No. 2015-36307

### SUMMARY OF THE INVENTION

### Problem to be Solved by the Invention

Incidentally, in the above-described caser, in order to form the crease in the entire area along the horizontal direction (the left-and-right direction and the front-and-rear direction) of the corrugated cardboard box, the convex member and the concave member are formed to be long in the horizontal direction corresponding to the dimension of the corrugated cardboard box. In order to form the crease in the entire area of the side wall and the others of the corrugated cardboard box in the horizontal direction at one time, it is necessary to press the convex member and the concave member against the side wall and the others with equal force in the longitudinal direction. However, in the convex member and the concave member which are long in the horizontal direction, because the pressure is partially increased or decreased, the depth of the crease is not constant in the horizontal direction, and therefore the appropriate crease cannot be formed. In addition, if the dimension (the area of the bottom surface (footprint) ) of the corrugated cardboard box is changed, the convex member and the concave member must be replaced with those matching the dimensions of the corrugated cardboard box, which takes time and labor for the replacement work, and the caser must be stopped for the replacement work, which lowers productivity.

In view of the above circumstances, the present invention provides a packaging apparatus capable of forming an appropriate horizontal crease line on a wall portion of a cylindrical body.

### Means of Solving the Problems

A packaging apparatus according to the present invention packages a stored object in a packaging box having a cylindrical body with a bottom portion closed and changes a height of the packaging box dependent on a height of the stored object. The packaging apparatus includes a height measuring part which measures a height of the stored object stored in the cylindrical body with a top surface opening portion opened, and a scoring part which forms a horizontal crease in a wall of the cylindrical body based on a result of the height measuring part to divide the wall into a side wall and an upper flap. The scoring part includes a roller part which holds the wall of the cylindrical body and moves in a horizontal direction while rolling on both front and rear surfaces of the wall to form the horizontal crease.

In this case, the scoring part may include a first scoring part including the roller part which forms the horizontal crease in a pair of the walls facing each other in a first direction when the cylindrical body is viewed from a plane, and a second scoring part including the roller part which forms the horizontal crease in a pair of the walls facing each other in a second direction perpendicular to the first direction when the cylindrical body is viewed from a plane.

In this case, the roller part may include a pair of outer rollers which are disposed in a horizontal direction along the horizontal crease via an interval and rotates around an axis while being pressed on a front surface of the wall, and an inner roller which is disposed to face a space between the pair of outer rollers and rotates around an axis while being pressed on a rear surface of the wall.

In this case, the inner roller may be disposed to face the space between the outer rollers at a position shifted downward with respect to the outer rollers.

### Effect of the Invention

According to the present invention, a packaging apparatus capable of forming an appropriate horizontal crease line on a wall portion of a cylindrical body can be provided.

### BRIEF DESCRIPTION OF THE DRAWINGS

FIG. 1 is a side view schematically showing a packaging apparatus according to one embodiment of the present invention;

FIG. 2 is a plan view showing a blank of a packaging box according to the embodiment of the present invention;

FIG. 3 is a perspective view showing the packaging box temporarily assembled according to the embodiment of the present invention;

FIG. 4 is a plan view schematically showing a scoring part of the packaging apparatus according to the embodiment of the present invention;

FIG. 5 is a perspective view of a part of the scoring part of the packaging apparatus according to the embodiment of the present invention;

FIG. 6 is a plan view schematically showing a separation part of the packaging apparatus according to the embodiment of the present invention;

FIG. 7 is a perspective view showing a part of the separation part of the packaging apparatus according to an embodiment of the present invention;

FIG. 8 is a perspective view showing the packaging box formed with a third fold line, according to the embodiment of the present invention;

FIG. 9 is a side view explaining a separation process by the packaging apparatus according to the embodiment of the present invention;

FIG. 10 is a side view showing the packaging apparatus according to the embodiment of the present invention, in which the separation process is completed;

FIG. 11 is a plan view showing the packaging apparatus according to the embodiment Of the present invention, in which the separation process is completed;

FIG. 12 is a perspective view showing the sealed packaging box (maximum height) according to the embodiment of the present invention; and

FIG. 13 is a perspective view showing the sealed packaging box (minimum height) according to the embodiment of the present invention.

### EMBODIMENTS FOR CARRYING OUT THE INVENTION

Hereinafter, with reference to the attached drawings, one embodiment of the present invention will be described. Fr, Rr, L, R, U, and D in the drawings indicate the front, rear, left, right, upper, and down. The front-and-rear direction, the left-and-right direction, and the upper-and-down direction are orthogonal to each other. Although the directional and positional terms are used in the specification, they are for convenience of description and are not intended to limit the scope of the invention. The terms indicating the direction and position are based on the direction and position in a state where the packaging apparatus is used.

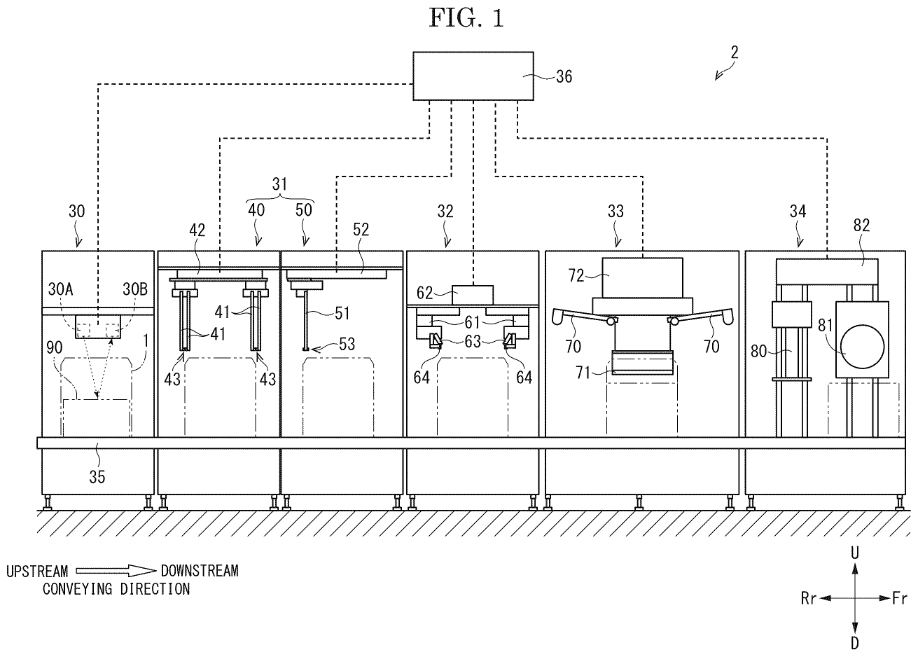

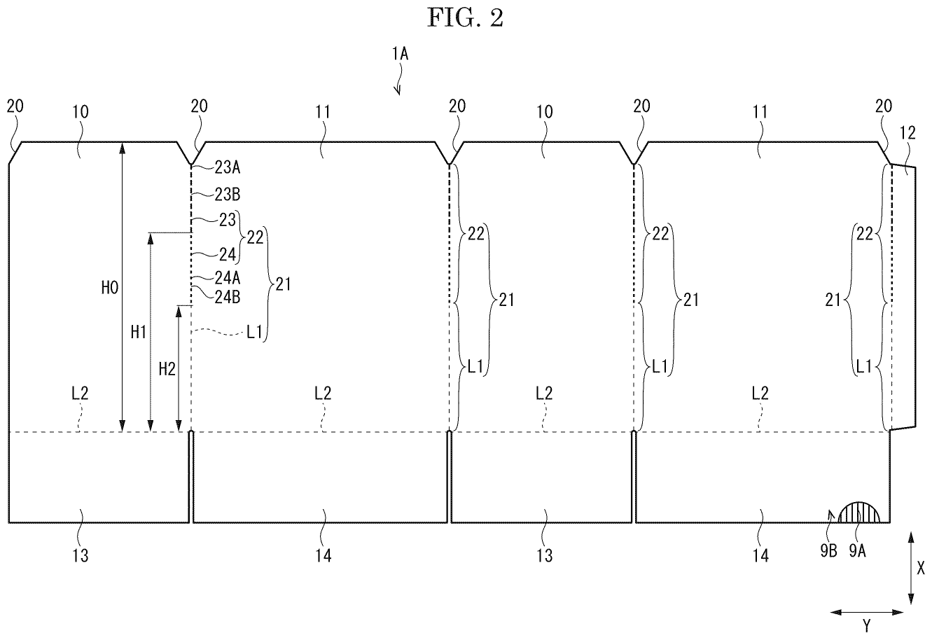

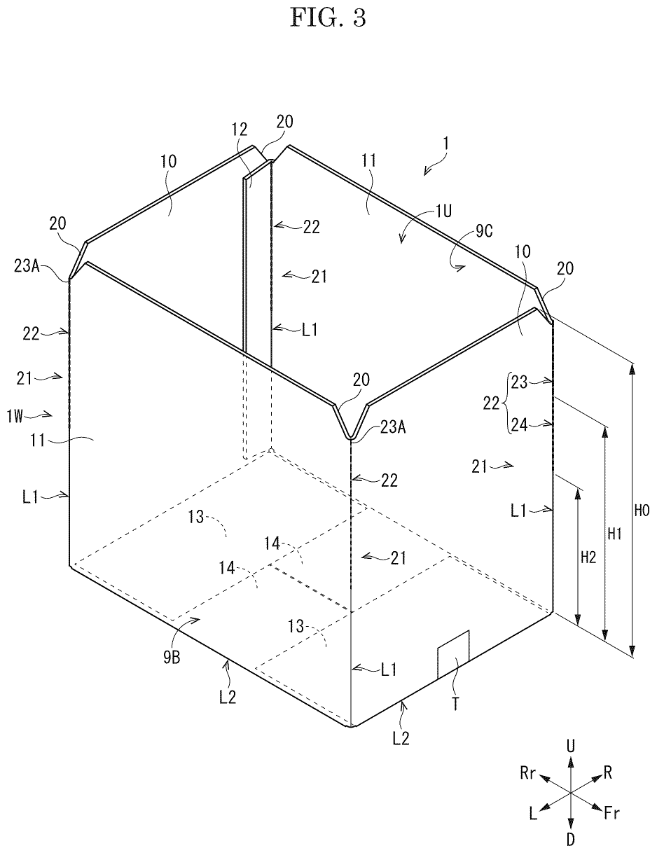

With reference to FIG. 1 to FIG. 3, a packaging apparatus 2 and a packaging box 1 according to the embodiment will be described. FIG. 1 is a side view schematically showing the packaging apparatus 2. FIG. 2 is a plan view showing a blank 1A of the packaging box 1. FIG. 3 is a perspective view showing the packaging box 1 in a temporarily assembled state.

The packaging apparatus 2 is an apparatus for packaging a stored object 90 in a packaging box 1. The packaging apparatus 2 has a function of changing a height of the packaging box 1 in accordance with a height of the stored object 90 when the stored object 90 is packaged in one type of the packaging box 1. That is, the packaging apparatus 2 can package (pack) the stored object 90 in one type of the packaging box 1 even if the stored object 90 has a different height. It should be noted that the packaging apparatus 2 can also package the stored object 90 while changing the height of each of two or more types of the packaging boxes 1 having different bottom (or top) areas (footprints).

[Packaging Box] First, the packaging box 1 formed by the packaging apparatus 2 will be described. The packaging box 1 is formed from the blank 1A shown in FIG. 2. The blank 1A is formed by punching out one corrugated board sheet made of paper by a die or the like. The corrugated board sheet is, for example, a double-sided corrugated board sheet in which an outer liner 9B (front surface) and an inner liner 9C (rear surface) are bonded to a corrugated core base 9A. In this specification, a direction parallel to the corrugated core base 9A of the corrugated board sheet is referred to as “a step direction”, and a direction perpendicular to the step direction is referred to as “a flow direction”. In the drawings, “X” indicates “the step direction” and “Y” indicates “the flow direction”.

[Blank] As shown in FIG. 2, the blank 1A includes a pair of first base walls 10, a pair of second base walls 11, a pair of lower inner flaps 13, and a pair of lower outer flaps 14. Since the pair of first base walls 10 have substantially the same shape, one of the pair of first base walls 10 will be mainly described in the specification. For similar reasons, one of the pair of second base walls 11, one of the pair of lower inner flaps 13, and one of the lower outer flaps 14 are mainly described in the specification. Further, in this specification, when the first base wall 10 and the second base wall 11 are collectively described, they are sometimes simply referred to as “the base walls 10, 11”.

<First Base Wall, Second Base Wall>The first base wall 10 is formed in a substantially rectangular shape whose long side is along the step direction. The second base wall 11 is formed in a substantially rectangular shape having the same dimension in the step direction as the first base wall 10 and whose long side is along the flow direction. The pair of first base walls 10 and the pair of second base walls 11 are alternately disposed in the flow direction and are connected to each other via fold portions 21. A margin piece 12 is connected to one end of the second base wall 11 in the flow direction through the fold portion 21. Although the details will be described later, the pair of first base walls 10 and the pair of second base walls 11 are annularly connected via the margin piece 12 to form a cylindrical body 1W (see FIG. 3).

(Notched Portion) At both the end corner portions of the base walls 10, 11 in the flow direction and at the boundaries (the fold portions 21) between the first base wall 10 and the second base wall 11, notched portions 20 are formed from one end (the upper end) toward the other end in the step direction. The notched portion 20 is recessed in a substantially V-shape (substantially triangular shape) which gradually narrows in width from one end (the upper end) toward the other end (the lower end) in the step direction. Incidentally, the notched portions 20 formed at the end corner portions of the base walls 10, 11 in the flow direction have a shape formed by substantially halving the other notched portion 20, and forms substantially the same shape as the other notched portion 20 when the cylindrical body 1W is formed.

(Fold Portion) The fold portion 21 has a first fold line L1 formed on the other side in the step direction (the lower side) and a break auxiliary line 22 formed on one side in the step direction (the upper side). The first fold line L1 and the break auxiliary line 22 are aligned on the same line along the step direction. The break auxiliary line 22 is formed slightly longer in the step direction than the first fold line L1. The first fold line L1 is, for example, a general-purpose score line formed by crushing the corrugated cardboard sheet in the thickness direction from the inner liner 9C. The break auxiliary line 22 is, for example, a perforation formed by alternately aligning cuts 23A, 24A and seams 23B, 24B. The cuts 23A, 24A are formed linearly penetrating the corrugated board sheet in the thickness direction, and the seams 23B, 24B are portions between the adjacent cuts 23A, 24A (portions without the cuts 23A, 24A).

(Break Auxiliary Line) The break auxiliary line 22 has a first break line 23 and a second break line 24. The first break line 23 and the second break line 24 are formed to have substantially the same length in the step direction. The first break line 23 is formed from the upper end of the base walls 10, 11 (the lowermost portion of the notched portion 20) to the substantially center of the entire length of the break auxiliary line 22. The uppermost cut 23A of the first break line 23 is connected to the lowermost portion of the notched portion 20. The second break line 24 is formed between the lower end of the first break line 23 and the upper end of the first fold line L1. The second break line 24 is formed to be more difficult to break than the first break line 23. Specifically, the cut 24A of the second break line 24 is formed shorter than the cut 23A of the first break line 23, and the seam 24B of the second break line 24 is formed longer than the seam 23B of the first break line 23. Although the details will be described later, the lower end position of the first break line 23 (the upper end position of the second break line 24) corresponds to the maximum height (H1) of the packaging box 1 after sealing, and the lower end position of the second break line 24 (the upper end position of the first fold line L1) corresponds to the minimum height (H2) of the packaging box 1 after sealing.

<Lower Inner Flap, Lower Outer Flap>The lower inner flap 13 is connected to the other end (the lower end) of the first base wall 10 in the step direction via a second fold line L2 (for example, a general-purpose score line). The lower inner flap 13 is formed in a substantially rectangular shape having substantially the same dimension as the first base wall 10 in the flow direction and whose long side is along the flow direction. The dimension (extended dimension) of the lower inner flap 13 in the step direction is substantially a half the dimension of the first base wall 10 in the flow direction. The lower outer flap 14 is connected to the other end (the lower end) of the second base wall 11 in the step direction via the second fold line L2. The lower outer flap 14 is formed in a substantially rectangular shape having substantially the same dimension as the second base wall 11 in the flow direction and whose long side is along the flow direction. The dimension (extended dimension) of the lower outer flap 14 in the step direction is the same as the extended dimension of the lower inner flap 13.

Although the first fold line L1 and the second fold line L2 are general-purpose score lines, they are not limited thereto, and any structure for folding the corrugated board sheet in a desired direction may be used, such as a lead line having perforations formed on a general-purpose score line.

[Initial State of Packaging Box] Although not shown, the flatly folded packaging box 1 is formed from the blank 1A. Specifically, the first base wall 10 and the second base wall 11 located on both sides of the blank 1A in the flow direction are folded back inward by approximately 180 degrees along the fold portions 21, and the margin piece 12 is bonded to the rear surface (the inner liner 9C) of the first base wall 10 on the opposite side to the margin piece 12. Thus, the packaging box 1 is in the initial state of being folded in double.

[Temporary Assembly 44 Packaging Box] The packaging box 1 in the initial state is temporarily assembled to store the stored object 90 and to package (seal) the stored object 90 by the packaging apparatus 2. Specifically, as shown in FIG. 3, the packaging box 1 in the initial state is raised so that the pair of first base walls 10 and the pair of second base walls 11 are substantially orthogonal to each other. The pair of first base walls 10 and the pair of second base walls 11 form the cylindrical body 1W having a substantially rectangular cylindrical shape with upper and lower end surfaces opened.

Next, the lower inner flaps 13 are folded inwardly at a substantially right angle along the second fold lines L2, and then the lower outer flaps 14 are folded inwardly at a substantially right angle along the second fold lines L2. The tips of the pair of lower inner flaps 13 are separated from each other, and the tips of the pair of lower outer flaps 14 are abutted on each other and laminated on the surfaces of the pair of lower inner flaps 13. An adhesive tape T is stuck to the abutting portion of the pair of lower outer flaps 14. The lower inner flaps 13 and the lower outer flaps 14 serve as a bottom portion closing the lower end surface (the bottom surface) of the cylindrical body 1W.

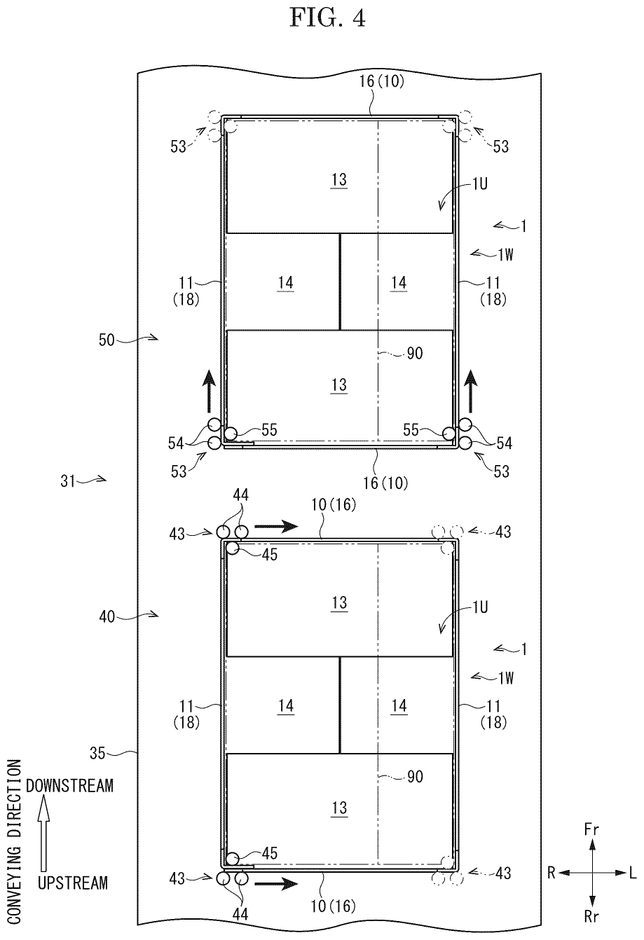

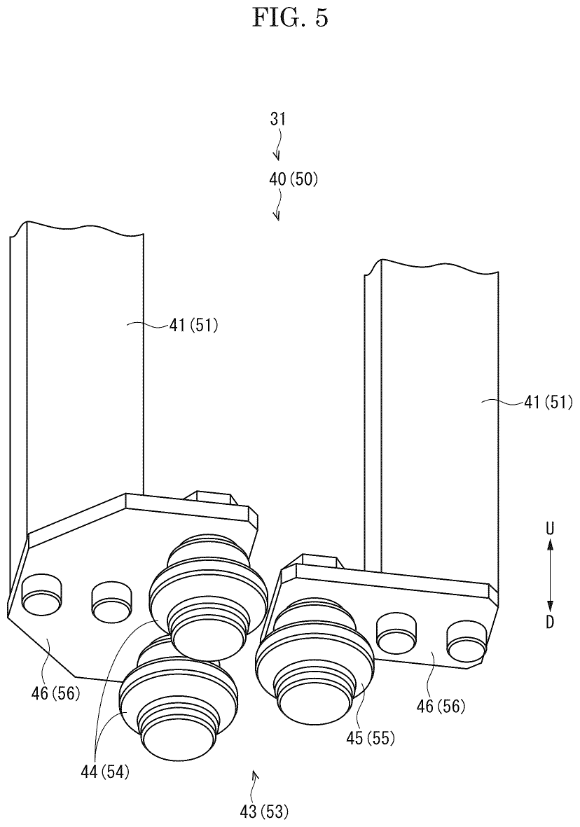

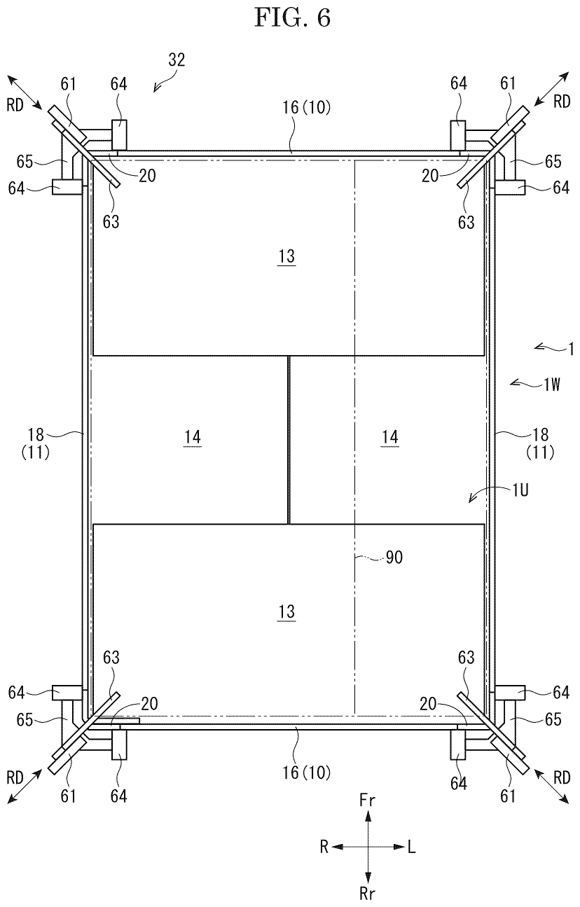

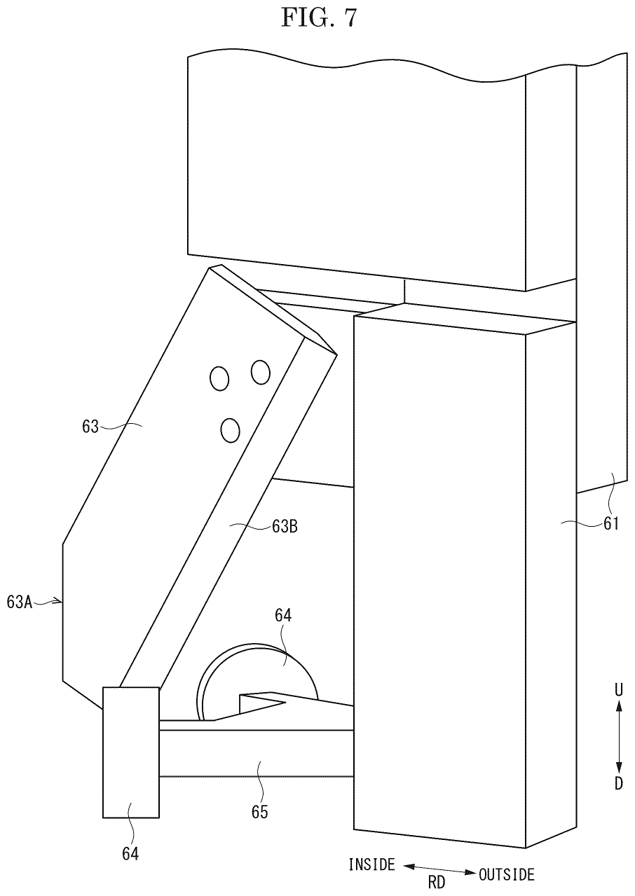

Thus, the packaging box 1 is temporarily assembled. In the temporarily assembled packaging box 1, the bottom surface of the cylindrical body 1W is closed, a top surface opening portion 1U is opened in the upper end surface of the cylindrical body 1W, and the base walls 10, 11 are connected by the fold portions 21. The notched portion 20 is recessed so as to become narrower downward in width at the corner portions of the top surface opening portion 1U of the cylindrical body 1W. The break auxiliary line 22 weakens the upper portion of the vertical ridge line (the boundary between the first base wall 10 and the second base wall 11) of the cylindrical body 1W with the bottom portion closed. The first break line 23 is formed from the corner portion (the lowermost portion of the notched portion 20) of the top surface opening portion 1U of the cylindrical body 1W to a position corresponding to the maximum height (H1) of the packaging box 1 after sealing. The second break line 24 is formed from the lower end of the first break line 23 to a position corresponding to the minimum height (H2) of the packaging box 1 after sealing. The stored object 90 is stored in the temporarily assembled packaging box 1 (the cylindrical body 1W), and the packaging box 1 storing the stored object 90 is introduced into the packaging apparatus 2 (see FIG. 1).

[Packaging Apparatus] Next, with reference to FIG. 1, FIG. 4 to FIG. 7, the packaging apparatus 2 will be described in detail. FIG. 4 is a plan view schematically showing a scoring part 31. FIG. 5 is a perspective view showing a part of the scoring part 31. FIG. 6 is a plan view schematically showing a separation part 32. FIG. 7 is a perspective view showing a part of the separation part 32.

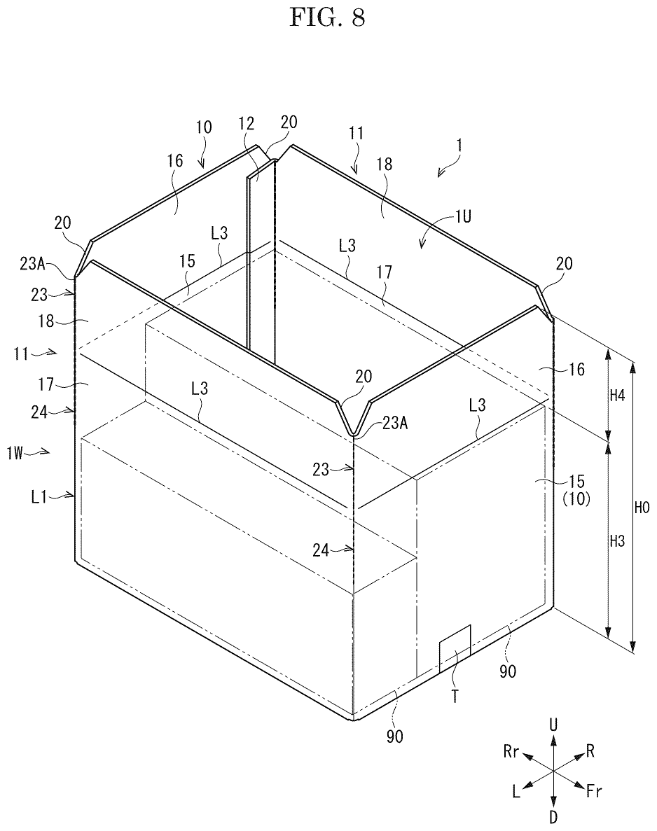

As shown in FIG. 1, the packaging apparatus 2 is provided with a height measuring part 30, the scoring part 31, the separation part 32, a folding part 33, and a sealing part 34. The packaging apparatus 2 is provided with a conveyor 35 for intermittently conveying the packaging box 1. The packaging apparatus 2 is provided with a control part 36 for appropriately controlling each of the parts 30 to 34 and the conveyor 35. The height measuring part 30, the scoring part 31, the separation part 32, the folding part 33, and the sealing part 34 are disposed in a row in this order from the upstream to the downstream in the conveying direction of the packaging box 1. The conveyor 35 is laid over the entire area of the height measuring part 30, the scoring part 31, the separation part 32, the folding part 33 and the sealing part 34. In this specification, the terms “upstream” or “downstream” refers to as the upstream or downstream in the conveying direction of the packaging box 1.

<Height Measurement Part>As shown in FIG. 1, the height measuring part 30 measures a height of the stored object 90 stored in the cylindrical body 1W (the temporarily assembled packaging box 1) with the top surface opening portion 1U opened. The height measuring part 30 includes a laser light source 30A which emits a belt-like laser beam to the stored object 90, and a light receiving element 30B which receives reflected light reflected on the surface of the stored object 90, and measures a height (shape) of the stored object 90 using the principle of the optical cutting method. The height measuring part 30 is electrically connected to the control part 36, and is driven and controlled by the control part 36. The light reception information by the light receiving element 30B (the measurement result by the height measuring part 30) is transmitted to the control part 36.

<Scoring Part>The scoring part 31 forms a third fold line L3 (a horizontal crease line) on the base walls 10, 11 (the wall portions) of the cylindrical body 1W in accordance with the height of the stored object 90 (see FIG. 8 described later). The scoring part 31 includes a first scoring part 40 which forms the third fold line L3 on the pair of first base walls 10 on the short side of the top surface opening portion 1U, and a second scoring part 50 which forms the third fold line L3 on the pair of second base walls 11 on the long side of the top surface opening portion 1U. The second scoring part 50 is disposed on the downstream of the first scoring part 40 (see FIG. 1).

<First Scoring Part>As shown in FIG. 1, the first scoring part 40 includes two pairs of first arms 41, a first drive part 42, and a pair of first roller parts 43. Since the two pairs of first arms 41 provided corresponding to one first base wall 10 have substantially the same structure, one pair of the two pairs of first arms 41 will be mainly described in the specification. Since the pair of first roller parts 43 have substantially the same structure, one of the pair of first roller parts 43 will be mainly described in the specification.

(First Arm, First Drive Part) The pair of first arms 41 are suspended substantially vertically from the first drive part 42. The pair of first arms 41 are provided substantially in parallel with each other at an interval in the front-and-rear direction (the conveying direction). The first drive part 42 lifts and lowers the whole of the two pairs of first arms 41, and moves them in the front-and-rear direction and in the left-and-right direction (the width direction perpendicular to the conveying direction). In addition, the first drive part 42 moves the pair of first arms 41 close to and away from each other. The first drive part 42 is electrically connected to the control part 36, and is driven and controlled by the control part 36. Although the details will be described later, when the first drive part 42 lowers the pair of first arms 41 toward the temporarily assembled packaging box 1, the first base wall 10 relatively enters between the pair of first arms 41, and the pair of first arms 41 face each other across the first base wall 10.

(First Roller Part) As shown in FIG. 4 and FIG. 5, the first roller part 43 includes a pair of first outer rollers 44 and a first inner roller 45. The first outer roller 44 and the first inner roller 45 are formed in a substantially cylindrical shape (a substantially disk-shape). The pair of first outer rollers 44 are attached to the lower end portion of the outer first arm 41 of the pair of first arms 41 disposed across the first base wall 10, via a first bracket 46. The pair of first outer rollers 44 are disposed side by side with an interval in the left-and-right direction (the horizontal direction along the third fold line L3), and are supported by the first bracket 46 so as to be rotatable around axes. The first inner roller 45 is attached to the lower end portion of the inner first arm 41 of the pair of first arms 41 disposed across the first base wall 10, via the first bracket 46. The first inner roller 45 is disposed to face the space between the pair of first outer rollers 44, and is supported by the first bracket 46 so as to be rotatable around an axis.

<Second Scoring Part>As shown in FIG. 1, the second scoring part 50 includes two pairs of second arms 51, a second drive part 52, and a pair of second roller parts 53. Since the two pairs of second arms 51 provided corresponding to one second base wall 11 have substantially the same structure, one of the two pairs of second arms 51 will be mainly described in the specification. Since the pair of second roller parts 53 have substantially the same structure, one of the pair of second roller parts 53 will be mainly described in the specification. In FIG. 1, only the left second arm 51 and the left second roller part 53 are shown. Since the second roller part 53 and the others have substantially the same structure as the first roller part 43 and the others, the second roller part 53 and the others will be described with reference to FIG. 5 used for the description of the first roller part 43 and the others.

(Second Arm, Second Drive Part) The pair of second arms 51 are suspended substantially vertically from the second drive part 52. The pair of second arms 51 are provided substantially in parallel with each other at an interval in the left-and-right direction. The second drive part 52 lifts and lowers the whole of the pair of second arms 51, and moves them in the front-and-rear direction and in the left-and-right direction. In addition, the second drive part 52 moves the pair of second arms 51 close to or away from each other. The second drive part 52 is electrically connected to the control part 36, and is driven and controlled by the control part 36. As will be described later in detail, when the second drive part 52 lowers the pair of second arms 51 toward the temporarily assembled packaging box 1, the second base wall 11 relatively enters between the pair of second arms 51, and the pair of second arms 51 face each other across the second base wall 11.

(Second Roller Part) As shown in FIG. 4 and FIG. 5, the second roller part 53 has a pair of second outer rollers 54 and a second inner roller 55. The second outer roller 54 and the second inner roller 55 are formed in a substantially cylindrical shape (a substantially disk-shaped). The pair of second outer rollers 54 are attached to the lower end portion of the outer second arm 51 of the pair of second arms 51 disposed across the second base wall 11, via a second bracket 56. The pair of second outer rollers 54 are disposed side by side with an interval in the front-and-rear direction (the horizontal direction along the third fold line L3), and are supported by the second bracket 56 so as to be rotatable around axes. The second inner roller 55 is attached to the lower end portion of the inner second arm 51 of the pair of second arms 51 disposed across the second base wall 11, via the second bracket 56. The second inner roller 55 is disposed to face the space between the pair of second outer rollers 54, and is supported by the second bracket 56 so as to be rotatable around an axis.

(Details of Outer Roller and Inner Roller) With reference to FIG. 4 and FIG. 5, the first roller part 43 and the second roller part 53 will be described in detail. In this specification, when the first roller part 43 and the second roller part 53 are collectively described, they may be referred to as “the roller parts 43, 53”, when the first outer rollers 44 and the second outer rollers 54 are collectively described, they may be referred to as “the outer rollers 44, 54”, and when the first inner roller 45 and the second inner roller 55 are collectively described, they may be referred to as “the inner rollers 45, 55”.

The outer rollers 44, 54 and the inner rollers 45, 55 are made of metal such as carbon steel, for example, and are all formed in the same shape. £ The outer rollers 44, 54 and the inner rollers 45, 55 are formed in a substantially disk shape having a diameter of 20 mm. The outer rollers 44, 54 and the inner rollers 45, 55 have portions protruding in a substantially trapezoidal shape outward in the radial direction. A distance (a center distance) between the pair of first outer rollers 44 and a distance (a center distance) between the pair of second outer rollers 54 is about 20 mm, which is the same as the diameter. The diameters of the outer rollers 44, 54 and the inner rollers 45, 55 are preferably set in a range of 5 mm to 60 mm. The distance between the pair of outer rollers 44, 54 may be changed according to the diameter of the pair of outer rollers 44, 54. The outer rollers 44, 54 and the inner rollers 45, 55 may have diameters different from each other.

The inner rollers 45, 55 are disposed to face the space between the outer rollers 44, 54 at positions shifted downward from the outer rollers 44, 54. More specifically, the inner rollers 45, 55 (the center of the thickness) are disposed at positions shifted about 2 mm below the outer rollers 44, 54 (the center of the thickness). The amount of shift between the inner rollers 45, 55 and the outer rollers 44, 54 is preferably set in a range of, for example, 0 mm to 6 mm (the thickness of the protruding portions of the inner rollers 45, 55).

As shown in FIG. 4, the roller parts 43, 53 of the scoring part 31 form the third fold line L3 by moving horizontally (see the bold arrow shown in FIG. 4) while rolling on the front and rear surfaces of the base walls 10, 11 with the base walls 10, 11 of the cylindrical body 1W held between them. The first roller part 43 forms the third fold lines L3 on the pair of first base walls 10 facing each other in the front-and-rear direction (the first direction) when the cylindrical body 1W is viewed from a plane. The second roller part 53 forms the third fold lines L3 on the pair of second base walls 11 facing each other in the left-and-right direction (the second direction perpendicular to the first direction) when the cylindrical body 1W is viewed from a plane. The outer rollers 44, 54 rotate around the axes while their protruded portions pressed against the front surfaces of the base walls 10, 11. The inner rollers 45,55 rotate around the axes while their protruded portions pressed against the rear surfaces of the base walls 10, 11. The inner rollers 45, 55 are disposed to be into contact with the pair of outer rollers 44, 54 across the base walls 10, 11. The third fold line L3 is a line obtained by crushing (recessing) the base walls 10, 11 (the corrugated cardboard sheet) in the thickness direction from the front and rear surfaces. More specifically, the recess on the rear surface (the inner liner 9C) of the base walls 10, 11 is located slightly lower than the recess on the front surface (the outer liner 9B) of the base walls 10, 11.

Although the details will be described later, the first base wall 10 is divided into the first side wall 15 and the upper inner flap 16 by the third fold line L3, and the second base wall 11 is divided into the second side wall 17 and the upper outer flap 18 by the third fold line L3 (see FIG. 8 described later). The pair of first side walls 15 and the pair of second side walls 17 are alternately connected through at least the first fold lines L1. The pair of upper inner flaps 16 and the pair of upper outer flaps 18 are alternately connected through via the break auxiliary lines 22 (at least the first break line 23). In this specification, when the first side wall 15 and the second side wall 17 are collectively described, they may be referred to simply as “the side walls 15, 17”, and when the upper inner flap 16 and the upper outer flap 18 are collectively described, they may be referred to simply as “the upper flaps 16, 18”.

<Separation Part>The separation part 32 makes cuts into the cylindrical body 1W from the four corner portions of the top surface opening portion 1U of the temporarily assembled packaging box 1 along the break auxiliary lines 22. As shown in FIG. 1 and FIG. 6, the separation part 32 includes four separation arms 61, a separation drive part 62, four blades 63, and eight guide rollers 64. Since the four separation arms 61 and the four blades 63 are provided corresponding to the four corner portions of the top surface opening portion 1U, one of the separation arms 61 and one of the blades 63 corresponding to one corner portion will be mainly described in the specification. Since the eight guide rollers 64 are provided corresponding to the four corner portions of the top surface opening portion 1U, the two guide rollers 64 corresponding to one corner portion will be mainly described in the specification.

(Separation Arm, Separation Drive Part) As shown in FIG. 1, the separation arm 61 is suspended substantially vertically from the separation drive part 62. The four separation arms 61 are disposed so as to face the outside of the four corner portions of the top surface opening portion 1U when viewed from a plane (see FIG. 6). The separation drive part 62 lifts and lowers the whole of the four separation arms 61, and moves them in a direction (the radial direction RD) along a line for bisecting the corner portion (substantially right angle) of the cylindrical body 1W when viewed from a plane. The separation drive part 62 is electrically connected to the control part 36, and is driven and controlled by the control part 36. “The radial direction RD” is a direction inclined by approximately 45 degrees with respect to the first base wall 10 and the second base wall 11 of the packaging box 1 (the cylindrical body 1W) when viewed from a plane (see FIG. 6).

(Blade) As shown in FIG. 6 and FIG. 7, one end portion of the blade 63 is fixed to the separation arm 61. The blade 63 is made of, for example, synthetic resin such as monomer-cast nylon, and is formed in a substantially rectangular plate shape having a thickness of about 5 mm. That is, the blade 63 is formed in a non-sharp plate shape. Here, “the non-sharp” of the blade 63 refers to as a state (mode) in which the blade is so dull that it cannot cut (move while cutting) the corrugated cardboard sheet (the material sheet constituting the packaging box 1). The four blades 63 are provided in a posture inclined along the radial direction RD when viewed from a plane (see FIG. 6), and in a posture inclined downward from the outside toward the inside of the cylindrical body 1W when viewed from the side (the front surface and the lateral surface) (see FIG. 7). That is, the four blades 63 extend obliquely downward and inward from the four separation arms 61. A pull-out auxiliary surface 63A obtained by cutting off the upper corner portion into a substantially vertical surface is formed in the tip of the blade 63 (see FIG. 7). A tapered portion 63B whose thickness gradually becomes thinner toward the lower end (the packaging box 1) is formed in the lower side portion of the blade 63 (see FIG. 7). The tip (the lower end) of the tapered portion 63B is not sharp and has a slight thickness. The blade 63 is in an inclined posture with the tapered portion 63B directed downward (toward the packaging box 1).

Although the details will be described later, the separation part 32 separates the upper flaps 16, 18 connected via the break auxiliary line 22 along the break auxiliary line 22 by lowering the blade 63 pressed against the corner portion of the top surface opening portion 1U of the cylindrical body 1W to the third fold line L3. In the present specification, “the break” means that an integral body is broken, and specifically, it means that the seams 23B, 24B of the break auxiliary line 22 are broken (tears off). “The separation” means that an integral body is cut and divided separately, specifically, it means that the corrugated cardboard sheet (the upper flaps 16, 18) is torn (tears off) and divided. In ther words, in the specification, “the break” and “the separation” do not mean that a sharp blade or the like cuts (moves while cutting) the corrugated cardboard sheet, but mean that an integral body is torn while being broken locally.

(Guide Roller) As shown in FIG. 6 and FIG. 7, the two guide rollers 64 are attached to the lower portion of the separation arm 61 via a roller arm 65. the guide roller 64 is supported by the roller arm 65 at a position below the blade 63 so as to be rotatable around an axis. The guide roller 64 is made of, for example, synthetic resin such as monomer-cast nylon, and is formed in a substantially cylindrical shape (a substantially disk shape). The two guide rollers 64 are supported in a direction in which their rotational axes are perpendicular to each other. In the process of lowering the blade 63, the two guide rollers 64 rotate while being into contact with the front surfaces of the upper flaps 16, 18 connected to each other via the break auxiliary line 22 (see FIG. 6).

<Folding Part>As shown in FIG. 1, the folding part 33 includes a pair of inner fold arms 70 for folding the pair of upper inner flaps 16 along the third fold line L3, an outer fold arm 71 for folding one of the pair of upper outer flaps 18 along the third fold line L3, and a folding drive part 72 for driving the inner fold arms 70 and the outer fold arm 71. The folding drive part 72 is electrically connected to the control part 36, and is driven and controlled by the control part 36.

<Sealing Part>The sealing part 34 includes a sealing fold arm 80 for folding the other of the pair of upper outer flaps 18 along the third fold line L3, an attaching part 81 for attaching an adhesive tape T so as to fix the other upper outer flap 18 to one upper outer flap 18, and a sealing drive part 82 for driving the sealing fold arm 80 and the attaching part 81. The sealing drive part 82 is electrically connected to the control part 36, and driven and controlled by the control part 36.

<Conveyor>The conveyor 35 has a plurality of rollers (not shown) disposed side by side in the conveying direction. Each roller is supported by a frame (not shown) so as to be rotatable around an axis. Each roller is connected to a drive source such as an electric motor through a drive transmission mechanism such as a gear or a belt (neither of which is shown). Each roller is rotationally driven around the axis, thereby moving the packaging box 1 to the downstream side in the conveying direction. Further, the conveyor 35 is provided with a plurality of positioning parts (not shown) for holding the conveyed packaging box 1 at predetermined positions set such that the operations of the respective parts 30 to 34 are properly performed. The drive source and the positioning part are electrically connected to the control part 36, and are driven and controlled by the control part 36.

<Control Part>The control part 36 includes a storage part for storing programs, data, and the like, an arithmetic processing part for executing arithmetic processing according to the programs, and the like, and a communication part communicatively connected to each of the parts 30 to 34 and the conveyor 35. The storage part, the arithmetic processing part, and the communication part are electrically connected to each other so that they can communicate with each other. The storage part includes, for example, a storage medium such as ROM (Read Only Memory) or RAM (Random Access Memory), and the arithmetic processing part includes, for example, a CPU (Central Processing Unit). The control part 36 may include an operation terminal (not shown) for the operator to input various operations and to check output results from the control part 36. Further, it is preferable that data on the dimensions (length, width, height, and the others) of the temporarily assembled packaging box 1 and various parameters necessary for control are stored in the storage part in advance. The control part may be realized by a logic circuit (hardware) formed in an integrated circuit or the like instead of the CPU.

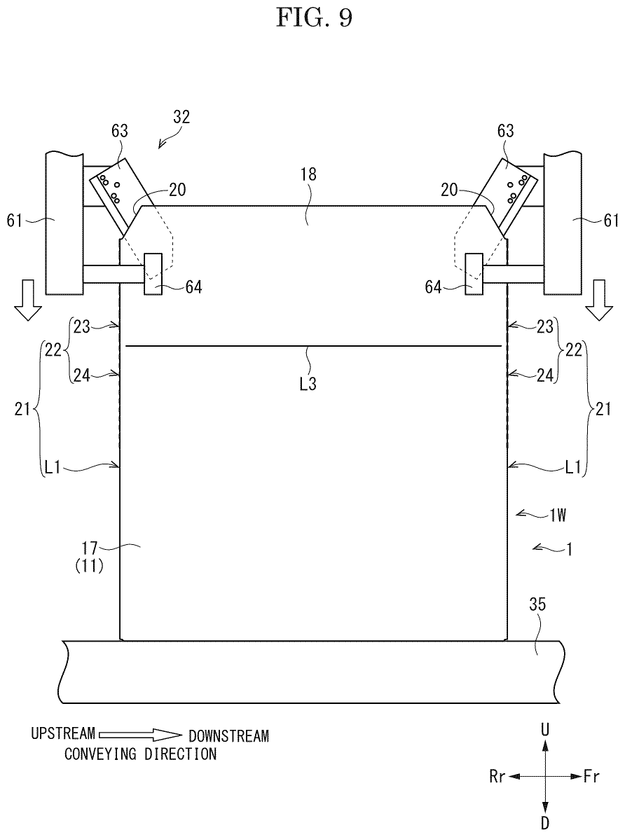

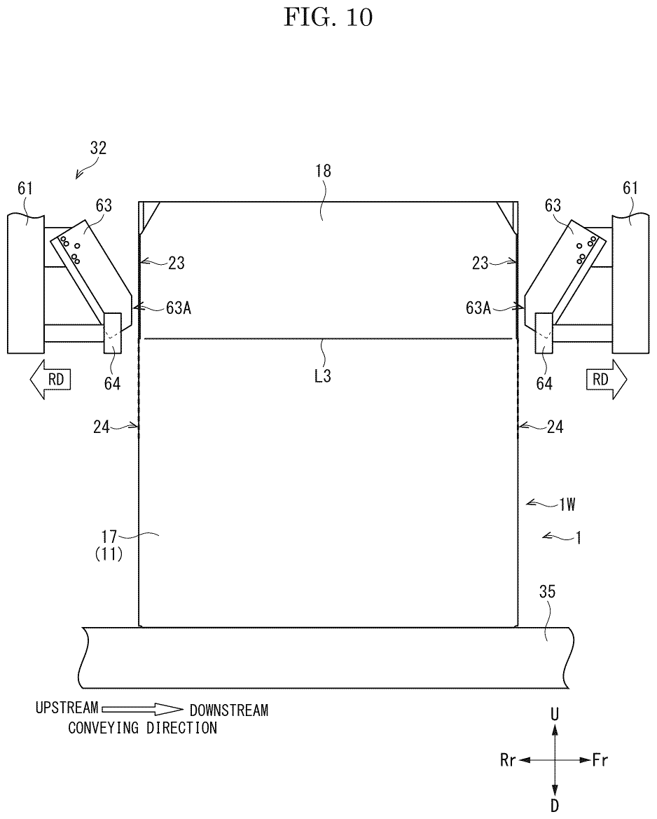

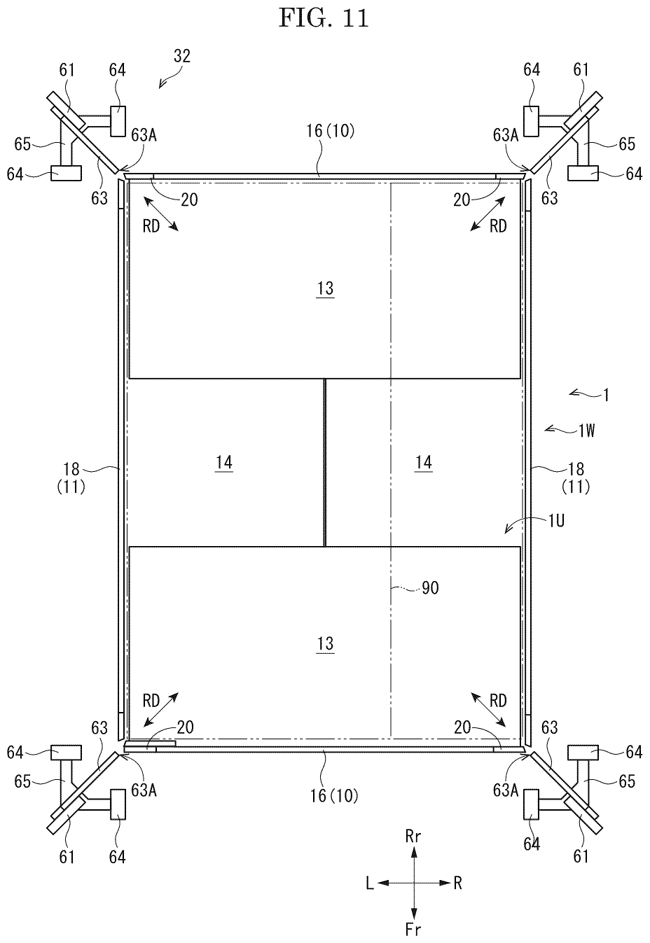

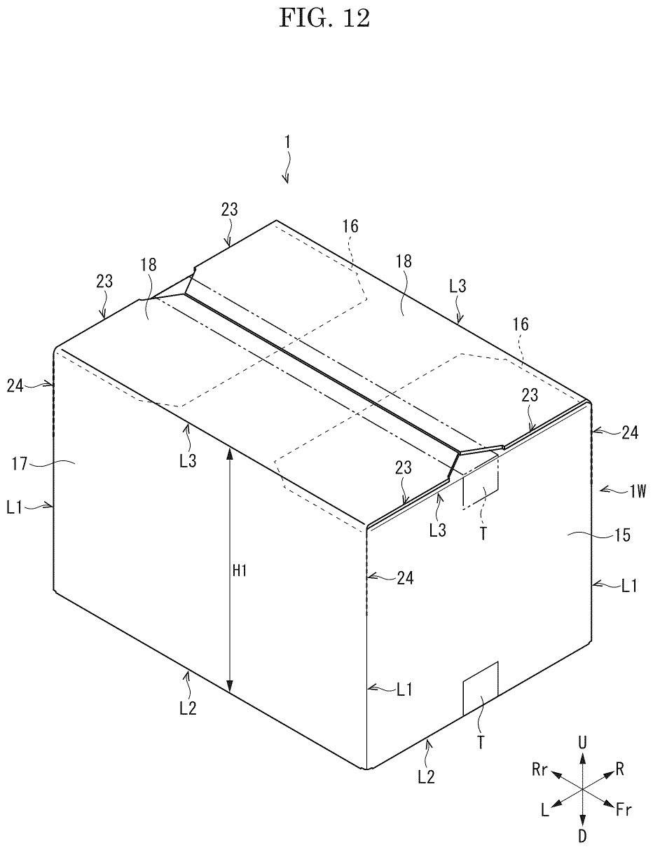

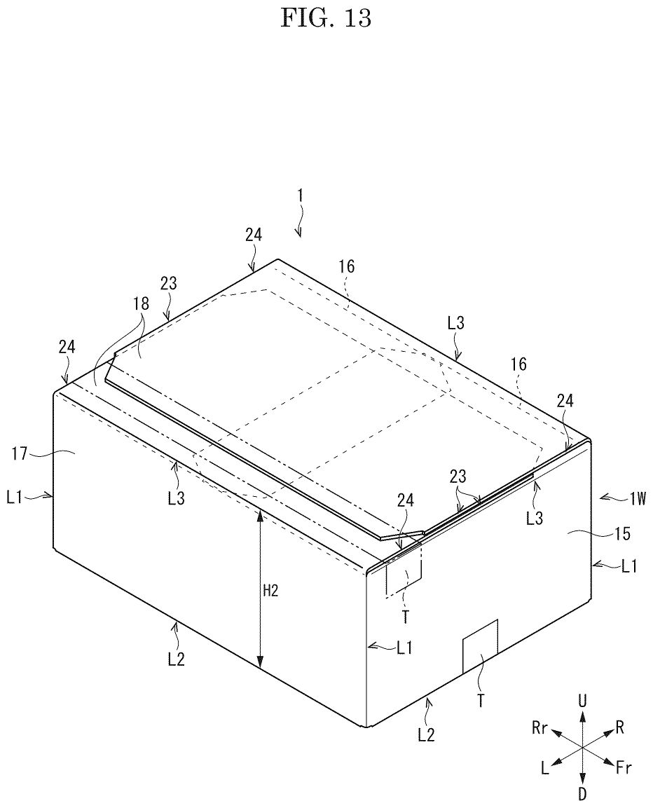

Incidentally, as an example of the first drive part 42, the second drive part 52, the separation drive part 62, the folding drive part 72, and the sealing drive part 82, an actuator such as an electric motor, a servo motor, a linear motor, a solenoid, a piston cylinder, or the like may be employed. The first drive part 42, the second drive part 52, the separation drive part 62, the folding drive part 72, and the sealing drive part 82 may include a drive transmission mechanism such as a gear or a pulley (belt) for transmitting the power of the actuator to the object to be driven (not shown). The drive parts 42, 52, 62, 72, and 82 and the control part 36 are connected to a power supply means (not shown).

[Operation of Packaging Apparatus] Next, with reference to FIG. 1, FIG. 4, FIG. 6, FIG. 8 to FIG. 13, an operation of the packaging apparatus 2 (a method for sealing the packaging box 1) will be described. FIG. 8 is a perspective view showing the packaging box 1 having the third fold line L3. FIG. 9 is a side view for explaining the separation process. FIG. 10 is a side view showing a state in which the separation process is completed. FIG. 11 is a plane view showing a state in which the separation process is completed. FIG. 12 is a perspective view showing the sealed packaging box 1 (maximum height (H1)). FIG. 13 is a perspective view showing the sealed packaging box 1 (minimum height (H2)).

First, the operator stores the stored object 90 in the temporarily assembled packaging box 1, places the packaging box 1 on the most upstream portion of the conveyor 35, and operates the control part 36 to operate the packaging apparatus 2.

<Height Measurement Process>the conveyor 35 conveys the packaging box 1 to the height measuring part 30, and holds (temporarily stops) the packaging box 1 by the positioning part. As shown in FIG. 1, the height measuring part 30 emits laser light from the laser light source 30A toward the stored object 90 in the packaging box 1, and receives the reflected light reflected on the surface of the stored object 90 by the light receiving element 30B (the height measuring process). The light reception data by the light receiving element 30B (the measurement result of the height measuring part 30) is transmitted to the control part 36, and the control part 36 calculates the height (H3) of the stored object 90 in the packaging box 1 based on the measurement result of the height measuring part 30 (see FIG. 8). When a plurality of the stored objects 90 of different heights are stored in the packaging box 1, a height of the tallest stored object 90 is calculated as the height (H3) of the stored object 90. Further, the control part 36 calculates a distance (H4) from the upper end of the cylindrical body 1W (the base walls 10, 11) of the packaging box 1 to the top of the stored object 90 (the height (HO) of the base walls 10, 11 —the height (H3) of the stored object 90) (see FIG. 8), and calculates the lowering amount of each of the arms 41, 51 and 61 based on this distance (H4). The lowering amount of each of the arms 41, 51 and 61 is set to be slightly higher than the height (H3) of the stored object 90 such that the roller parts 43, 53 and the blade 63 do not interfere with the stored object 90. The lowering amount of each of the arms 41, 51 and 61 may be calculated as, for example, the driving time of the drive parts 42, 52 and 62 or the rotation angle of the output shaft.

<Scoring Process>After measuring the height of the stored object 90, the scoring part 31 forms the third fold line L3 on the base walls 10, 11 of the cylindrical body 1W based on the measurement result of the height measuring part 30, and divides the base walls 10, 11 into the side walls 15, 17 and the upper flaps 16, 18 (the scoring process).

Specifically, the conveyor 35 conveys the packaging box 1 to the first scoring part 40, and holds the packaging box 1 by the positioning holding part. The two pairs of first arms 41 (the first roller parts 43) of the first scoring part 40 are disposed, for example, above the right end portions of the pair of first base walls 10 of the packaging box 1 (see FIG. 1 and FIG. 4). The first drive part 42 of the first scoring part 40 lowers the two pair of first arms 41 (the first outer rollers 44, the first inner roller 45) by the calculated lowering amount. The first base wall 10 of the packaging box 1 relatively enters between the pair of first arms 41 lowering. Next, the first drive part 42 moves the pair of first arms 41 in a direction in which they are close to each other, and holds the first base wall 10 between the pair of first outer rollers 44 and the first inner roller 45 (see FIG. 4). Subsequently, the first drive part 42 moves the pair of first arms 41 (the first roller parts 43) substantially horizontally from the right to the left while holding the first base wall 10 between the pair of first outer rollers 44 and the first inner roller 45 (see the bold arrow shown in FIG. 4). As a result, the third fold line L3 for dividing the first side wall 15 and the upper inner flap 16 is formed on the first base wall 10 (see FIG. 8). After the formation of the third fold line L3, the first drive part 42 returns (lifts) the first arms 41 (the first outer rollers 44, the first inner roller 45) to the initial position.

Next, the conveyor 35 conveys the packaging box 1 to the second scoring part 50, and holds the packaging box 1 by the positioning part. The two pairs of second arms 51 (the second roller parts 53) of the second scoring part 50 are disposed, for example, above the rear end portions (the upstream end portions) of the pair of second base walls 11 of the packaging box 1 (see FIG. 1 and FIG. 4). The second drive part 52 of the second scoring part 50 lowers the pair of second arms 51 by the calculated lowering amount. The second base wall 11 of the packaging box 1 relatively enters between the pair of second arms 51 lowering. Next, the second drive part 52 moves the pair of second arms 51 in a direction in which they are close to each other, and holds the second base wall 11 between the pair of second outer rollers 54 and the second inner roller 55 (see FIG. 4). Subsequently, the second drive part 52 moves the pair of second arms 51 (the second roller parts 53) substantially horizontally from the rear to the front while keeping the state in which the second base wall 11 is held between the pair of second outer rollers 54 and the second inner roller 55 (see the bold arrow shown in FIG. 4). As a result, the third fold line L3 for dividing the second side wall 17 and the upper outer flap 18 is formed on the second base wall 11 (see FIG. 8). After the formation of the third fold line L3, the second drive part 52 returns (lifts) the second arms 51 (the second outer rollers 54, the second inner roller 55) to the initial position.

In FIG. 8, as an example, the third fold line L3 is formed at substantially the same height as the boundary between the first break line 23 and the second break line 24, and corresponds to the maximum height (H1) of the packaging box 1 after sealing, but the present invention is not limited to thereto. The third fold line L3 may be formed horizontally (in the left-and-right direction and in the front-and-rear direction) in a range from the upper end of the first fold line L1 or above to the lower end of the first break line 23 or below. That is, the third fold line L3 may be formed so as to be perpendicular to the second break line 24. In the base walls 10, 11, the third fold line L3 is formed in a range excluding the radii of the outer rollers 44, 54 and the inner rollers 45, 55 from both ends in the horizontal direction (the fold portions 21). That is, in the vicinity of both ends of the base walls 10, 11 in the horizontal direction (in the left-and-right direction and in the front-and-rear direction), there is a small area where the third fold line L3 is not formed. The area where the third fold line L3 is not formed becomes smaller as the diameter (radius) of the outer rollers 44, 54 and the inner rollers 45, 55 becomes smaller.

<Separation Process>After the formation of the third fold line L3 on the base walls 10, 11, the separation part 32 makes cuts in the square upper portion of the cylindrical body 1W based on the measurement result of the height measuring part 30 (separation process).

Specifically, the conveyor 35 conveys the packaging box 1 to the separation part 32, and holds the packaging box 1 by the positioning part. The four separation arms 61 of the separation part 32 are disposed outside the four corner portions of the top surface opening portion 1U of the packaging box 1 when viewed from a plane (see FIG. 6). The separation drive part 62 of the separation part 32 lowers the four separation arms 61 (the blades 63) by the calculated lowering amount. At this time, even if the blade 63 is slightly displaced from the corner portion of the top surface opening portion 1U, the blade 63 lowers toward the break auxiliary line 22 while being guided by the notched portion 20 of the cylindrical body 1W (while being in sliding contact) (see FIG. 9). The blade 63 lowered along the notched portion 20 bites into the cut 23A of the first break line 23 connected to the notched portion 20. Since the tapered portion 63B is formed at the lower side portion of the blade 63, the blade 63 easily bites into the cut 23A. The blade 63 lowers to the position where the third fold line L3 is formed while breaking the seams 23B (24B) of the break auxiliary line 22. The blade 63 is held in the inclined posture and lowers while holding the upper flaps 16, 18 between the two guide rollers 64 (see FIG. 6 and FIG. 9). The two guide rollers 64 support the upper flaps 16, 18 which are separated by the blade 63 and tend to open outward.

As shown in FIG. 10 and FIG. 11, the separation part 32 (the separation drive part 62) lowers the blade 63 while keeping the blade 63 in the inclined posture, and then moves it substantially horizontally so as to pull out the blade 63 outside (in the radial direction RD) of the cylindrical body 1W while keeping the blade in the inclined posture. Since the blade 63 is formed with the pull-out auxiliary surface 63A substantially parallel to the break auxiliary line 22, the amount of movement in the pull-out direction (outside in the radial direction RD) can be reduced as compared with the case where the blade 63 has a simple rectangular plate shape. When the blade 63 is pulled out of the cylindrical body 1W, the separation drive part 62 returns (lifts) the separation arms 61 (the blade 63) to the initial position.

As described above, when the blade 63 of the separation part 32 lowers from the corner portion of the top surface opening portion 1U of the cylindrical body 1W to the third fold line L3 (the horizontal crease line), the upper flaps 16, 18 connected via the break auxiliary line 22 are separated along the break auxiliary line 22. In this embodiment, since the lower end position of the first break line 23 corresponds to the maximum height (H1) of the packaging box 1 after sealing, the blade 63 always breaks at least the whole of the first break line 23 of the break auxiliary line 22 regardless of the height of the packaging box 1 (the stored object 90). When the height of the packaging box 1 (the stored object 90) is low (small), the blade 63 breaks a part of the whole of the second break line 24 in addition to the first break line 23. In the packaging box 1 having the minimum height (H2), since the whole of the break auxiliary line 22 is broken, the side walls 15, 17 are connected only by the first fold line L1. On the other hand, in the packaging box 1 having a height other than the minimum height (H2), since a part of the whole of the second break line 24 is left unbroken, the side walls 15, 17 are connected by the first fold line L1 and at least a part of the second break line 24.

<Folding Process>After the upper flaps 16, 18 are separated, the conveyor 35 conveys the packaging box 1 to the folding part 33, and holds the packaging box 1 by the positioning part. The folding part 33 folds the upper flaps 16, 18 separated by the separation part 32 inward of the cylindrical body 1W along the third fold line L3 (the horizontal crease) (folding process). The folding drive part 72 of the folding part 33 turns the pair of inner fold arms 70 to fold the pair of upper inner flaps 16 along the third fold line L3, and then turns the outer fold arm 71 to fold one (for example, the left) upper outer flap 18 along the third fold line L3 (see FIG. 1). The one upper outer flap 18 is overlapped on the front surface of the pair of upper inner flaps 16 (see FIG. 12 or FIG. 13).

<Sealing Process>After the pair of upper inner flaps 16 and one upper outer flap 18 are folded, the conveyor 35 conveys the packaging box 1 to the sealing part 34, and holds the packaging box 1 by the positioning part. The sealing part 34 seals the packaging box 1 (sealing process). The sealing drive part 82 of the sealing part 34 turns the sealing fold arm 80 to fold the other upper outer flap 18 along the third fold line L3 (see FIG. 1). Here, in the sealed packaging box 1 having the maximum height (H1), the tips of the pair of upper outer flaps 18 separated along the first break lines 23 are abutted on each other (see FIG. 12). On the other hand, in the packaging box 1 having a height (for example, the minimum height (H2) ) other than the maximum height (H2), the tip side portion of the other upper outer flap 18 overlaps the surface of the one upper outer flap 18 (see FIG. 13). The attaching part 81 of the sealing part 34 adheres the adhesive tape T along the abutting portion of the pair of upper outer flaps 18 (see FIG. 12) or adheres the adhesive tape T along the tip portion of the other upper outer flaps 18 (see FIG. 13).

Thus, the top surface opening portion 1U of the cylindrical body 1W is closed, and the packaging box 1 is sealed (see FIG. 12 and FIG. 13).

In the packaging apparatus 2 according to the present embodiment described above, the roller parts 43, 53 of the scoring part 31 move while rolling on the front and rear surfaces of the base walls 10, 11 while holding the base walls, 11 of the cylindrical body 1W, thereby to form the third fold line L3. According to this configuration, since the roller parts 43, 53 move in the horizontal direction (the left-and-right direction and the front-and-rear direction) in a state where they slightly bite into both the front and rear surfaces of the base walls 10, 11, the third fold line L3 having a substantially constant depth can be formed in the horizontal direction (the entire movement range of the roller parts 43, 53). That is, the appropriate third fold line L3 can be formed on the base walls 10, 11 of the cylindrical body 1W. Further, by changing (adjusting) the amount of horizontal movement (movement distance) of the roller parts 43, 53, it is possible to flexibly cope with a change in the dimension (the area of the bottom surface (footprint)) of the packaging box 1. Thus, even if the dimension 4 the packaging box 1 is changed, the replacement work of the members is not required, and the packaging work by the packaging apparatus 2 can be continued (productivity is improved). It is preferable that the operator operates the operation terminal of the control part 36 to change (adjust) the amount of movement of the roller parts 43, 53.

In the packaging apparatus 2 according to the present embodiment, the pair of outer rollers 44 (54) are disposed outside the cylindrical body 1W, and one inner roller 45 (55) is disposed inside the cylindrical body 1W. The inner roller 45 (55) face the space between the pair of outer rollers 44 (54) across the base walls 10, 11. According to this configuration, even if one of the pair of outer rollers 44 (54) is brought as close as possible to the corner portion (the vertical ridge line) of the cylindrical body 1W, the inner roller 45 (55) can be disposed in the vicinity of the corner portion (the vertical ridge line) without interfering with the corner portion (the vertical ridge line). Thus, the third fold line L3 can be formed to the vicinity of both ends of the base walls 10, 11 in the horizontal direction (the left-and-right direction and the front-and-rear direction). That is, in the base walls 10, 11, it is possible to reduce a region where the third fold line L3 is not formed. Further, since the inner roller 45 (55) faces the space between the pair of outer rollers 44 (54), the base walls 10, 11 can be firmly held stably, and the firm third fold line L3 can be formed in the base walls 10, 11, compared with a case where the base walls 10, 11 are held by a single roller (not shown) on both the front and rear sides. Further, in the process of forming the third fold line L3, the outer roller 44 (54) positioned downstream in the moving direction forms the third fold line L3 on the surfaces of the base walls 10, 11, and then the outer roller 44 (54) positioned upstream in the moving direction move on the already formed third fold line L3. That is, since the outer rollers 44 (54) move at the same position (excluding both end portions in the moving direction) on the surfaces of the base walls 10, 11 over two times, the firm third fold line L3 can be formed on the surfaces of the base walls 10, 11. Thus, the upper flaps 16, 18 can be properly folded at the position where the third fold line L3 is formed.

In the packaging apparatus 2 according to the present embodiment, the inner roller 45 (55) is positioned slightly below the outer rollers 44 (54). According to this configuration, the recess (the third fold line L3) on the rear surfaces of the base walls 10, 11 is formed slightly below the recess (the third fold line L3) on the front surfaces of the base walls 10, 11, so that the upper flaps 16, 18 can be easily folded inward of the cylindrical body 1W.

In the packaging box 1 according to the present embodiment, the break auxiliary line 22 is a so-called perforation, but the present invention is not limited thereto. For example, the break auxiliary line 22 may be a zipper formed by aligning curved cuts at intervals, or a half-cut line formed by cutting about a half of the thickness from the rear surface of the corrugated board sheet (neither of which is shown).

Further, in the packaging box 1 according to the present embodiment, the cut 24A of the second break line 24 is shorter than the cut 23A of the first break line 23, and the seam 24B of the second break line 24 is longer than the seam 23B of the first break line 23 so that the second break line 24 is more difficult to break than the first break line 23, but the present invention is not limited thereto. For example, the cut 23A and the cut 24A may have the same length, and the seam 24B of the second break line 24 may be formed longer than the seam 23B of the first break line 23 (not shown). Further, for example, the seam 23B and the seam 24B may have the same length, and the cut 24A of the second break line 24 may be formed shorter than the cut 23A of the first break line 23 (not shown).

Further, in the packaging box 1 according to the present embodiment, the break auxiliary line 22 has the first break line 23 and the second break line 24, and the second break line 24 is set to be more difficult to break than the first break line 23, but the present invention is not limited thereto. For example, the break auxiliary line 22 may be formed so that ease of breaking is substantially constant throughout (not shown). Further, although the uppermost cut 23A of the break auxiliary line 22 (the first break line 23) is connected to the lowermost portion of the notched portion 20, the present invention is not limited thereto, and it may be away from the lowermost portion of the notched portion 20 (not shown).

In the packaging box 1 according to the present embodiment, the notched portion 20 is recessed in a substantially V-shape, but the present invention is not limited thereto. For example, the notched portion 20 may be recessed in a substantially U-shape or a substantially rectangular shape (not shown). The notched portion 20 may be omitted (not shown).

In the packaging box 1 according to the present embodiment, the lower inner flaps 13 and the lower outer flaps 14 are folded to form the bottom portion, and the tips of the pair of lower outer flaps 14 are abutted on each other, but the present invention is not limited thereto. For example, the tips of the pair of lower outer flaps 14 may be spaced apart (not shown). Further, for example, the bottom portion of the packaging box 1 may be a so-called one-touch bottom or a so-called lock bottom (not shown).

Further, in the packaging box 1 according to the present embodiment, the upper portion of the vertical ridge line of the cylindrical body 1W is weakened by the break auxiliary line 22, but the present invention is not limited thereto. For example, the break auxiliary line 22 may be omitted, and the fold portion 21 may be formed only by the first fold line L1 (not shown). That is, it may be considered that the vertical ridge line (the boundary between the first base wall 10 and the second base wall 11) of the cylindrical body 1W is weakened by being folded at the first fold line L1.

In the packaging apparatus 2 according to the present embodiment, the second scoring part 50 is disposed on the downstream side of the first scoring part 40, but not limited to this, and it may be disposed on the upstream side of the first scoring part 40 (not shown). That is, in the scoring process, the third fold line L3 may be formed on the second base wall 11, and then the third fold line L3 may be formed on the first base wall 10. Further, the scoring part 31 may be configured such that the first scoring part 40 and the second scoring part 50 are integrally formed to form the third fold line L3 on the four side surfaces of the cylindrical body 1W at the same time (not shown).

Further, in the packaging apparatus 2 according to the present embodiment, one inner roller 45 (55) of the scoring part 31 face the space between the pair of the outer rollers 44 (54), but the present invention is not limited thereto. For example, the outer rollers 44 (54) may be formed as one, and one inner roller 45 (55) and one outer roller 44 (54) may face each other (not shown). Further, for example, the inner roller 45 (55) may be formed as a pair, and the pair of outer rollers 44 (54) and the pair of inner rollers 45 (55) face each other (not shown). For example, the outer rollers 44 (54) may be formed as one, the inner rollers 45 (55) may be formed as a pair, and one outer roller 44 (54) may face the space between the pair of inner rollers 45 (55) (not shown).

In the packaging apparatus 2 according to the present embodiment, the inner rollers 45, 55 are slightly shifted downward from the outer rollers 44, 54, but the present invention is not limited thereto. The inner rollers 45, 55 may face the outer rollers 44, 54 at the same height (not shown).

Further, in the packaging apparatus 2 (the scoring part 31) according to the present embodiment, the third fold line L3 is formed to be perpendicular to the second break line 24 in a range from the upper end of the first fold line Ll or above to the lower end of the first break line 23 or below, but the present invention is not limited thereto. For example, the third fold line L3 may be formed horizontally (in the left-and-right direction and in the front-and-rear direction) in a range from the upper end of the first fold line L1 or above to below the upper end of the first break line 23 (not shown). That is, the third fold line L3 may be formed so as to be perpendicular to the first break line 23. In this case, the tips of the pair of upper outer flaps 18 are separated from each other (not shown).

In the packaging apparatus 2 according to the present embodiment, the blade 63 of the separation part 32 is in the inclined posture, but the present invention is not limited thereto. For example, the four blades 63 may be in a posture perpendicular to the first base wall 10 or perpendicular to the second base wall 11 when viewed from a plane (not shown). Also, for example, the blade 63 may be in a substantially horizontal posture when viewed from the side (the front side and the lateral side) (not shown).

Further, in the packaging apparatus 2 according to the present embodiment, the tapered portion 63B is formed at the lower side portion of the blade 63 of the separation part 32, but the present invention is not limited thereto. For example, a pair of the tapered portions 63B may be formed on both upper and lower side portions of the blade 63 (not shown). Thus, when the lower tapered portion 63B is worn, the top and bottom of the blade 63 can be turned back and the upper tapered portion 63B can be turned downward. Thus, the trouble of replacing the blade 63 with a new one can be saved. Further, the tapered portion 63B may be omitted, and the blade 63 may be formed in a plate shape having a substantially uniform thickness (not shown).

In the packaging apparatus 2 according to the present embodiment, the pull-out auxiliary surface 63A is formed in the blade 63 of the separation part 32, but the present invention is not limited thereto, and the pull-out auxiliary surface 63A may be omitted (not shown). The guide roller 64 of the separation part 32 may be omitted.

In the packaging apparatus 2 according to the present embodiment, the sealing part 34 seals the packaging box 1 using the adhesive tape T, but the present invention is not limited thereto. For example, the pair of upper outer flaps 18 may be bonded to the pair of upper inner flaps 16 via an adhesive, and the other upper outer flap 18 may be bonded to the one upper outer flap 18 via an adhesive (not shown).

In the packaging apparatus 2 according to the present embodiment, the folding part 33 and the sealing part 34 are provided, but the present invention is not limited thereto. For example, when the sealing operation is performed manually, such as when the operator closes the upper flaps 16, 18 and attaches the adhesive tape T, the folding part 33 and the sealing part 34 may be omitted. (not shown).

In the packaging apparatus 2 according to the present embodiment, the height measuring part 30, the scoring part 31, the separation part 32, the folding part 33, and the sealing part 34 are fixedly provided, and the packaging box 1 is conveyed by the conveyor 35, but the present invention is not limited thereto. For example, the packaging apparatus according to the modified example may omit the conveyor 35, fixedly arrange the packaging box 1 (not moved), and include a moving mechanism for moving the respective parts 30 to 34. That is, in the packaging apparatus according to the modified example, a fixing base (not shown) for fixing the packaging box 1 may be provided, and the moving mechanism may move the parts 30 to 34 intermittently on the packaging box 1.

Although the packaging box 1 according to the present embodiment is formed of a double-sided cardboard sheet made of paper, the present invention is not limited thereto. The packaging box 1 may be formed of a foldable material such as a single-sided corrugated board, a double-sided corrugated board, a triple wall corrugated board, a single paper (thick paper) or a synthetic resin board.

It should be noted that the description of the above embodiments shows one mode of the packaging apparatus and packaging box according to the present invention, and the technical scope of the present invention is not limited to the above embodiments. The invention may be variously modified, substituted, or modified without departing from the spirit of the technical idea, and the claims include all embodiments that may fall within the scope of the technical idea.

### LIST OF REFERENCE NUMERALS

1 Packaging box
1U Top surface opening portion
1W Cylindrical body
2 Packaging apparatus
10 First base wall (wall)
11 Second base wall (wall)
15 First side wall (side wall)
16 Upper inner flap (upper flap)
17 Second side wall (side wall)
18 Upper Outer Flap (upper flap)
30 Height measuring part
31 Scoring part
40 First scoring part
43 First roller part (roller part)
44 First outer roller (outer roller)
45 First inner roller (inner roller)
50 Second scoring part
53 Second roller part (roller part)
54 Second outer roller (outer roller)
55 Second inner roller (inner roller)
90 Stored object
L3 Third fold line (horizontal crease)

1. A packaging apparatus which packages a stored object in a packaging box having a cylindrical body with a bottom portion closed and changes a height of the packaging box dependent on a height of the stored object, the packaging apparatus comprising:
a height measuring part which measures a height of the stored object stored in the cylindrical body with a top surface opening portion opened, and
a scoring part which forms a horizontal crease in a wall of the cylindrical body based on a result of the height measuring part to divide the wall into a side wall and an upper flap wherein
the scoring part includes a roller part which holds the wall of the cylindrical body and moves in a horizontal direction while rolling on both front and rear surfaces of the wall to form the horizontal crease.

2. The packaging apparatus according to claim 1, wherein the scoring part includes:
a first scoring part including the roller part which forms the horizontal crease in a pair of the walls facing each other in a first direction when the cylindrical body is viewed from a plane, and
a second scoring part including the roller part which forms the horizontal crease in a pair of the walls facing each other in a second direction perpendicular to the first direction when the cylindrical body is viewed from a plane.

3. The packaging apparatus according to claim 1, wherein
the roller part includes:
a pair of outer rollers which are disposed in a horizontal direction along the horizontal crease via an interval and rotates around an axis while being pressed on a front surface of the wall, and
an inner roller which is disposed to face a space between the pair of outer rollers and rotates around an axis while being pressed on a rear surface of the wall.

4. The packaging apparatus according to claim 3, wherein
the inner roller is disposed to face the space between the outer rollers at a position shifted downward with respect to the outer rollers.
